(19) United States
(12) Patent Application Publication
(10) Pub. No.: US 2005/0224677 A1
(43) Pub. Date: Oct. 13, 2005

(54) Holder for holding and guiding bundles of cables in aircraft

(75) Inventors: Lutz Zeuner, Hardebek (DE); Lueder Kosiankowski, Jork (DE); Hans-Peter Guthke, Buxtehude (DE); Stefan Geltz, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/074,170

(22) Filed: Mar. 7, 2005

Related U.S. Application Data
(60) Provisional application No. 60/598,567, filed on Aug. 3, 2004.

(30) Foreign Application Priority Data
Mar. 8, 2004 (DE) 10 2004 011 184.7

(51) Int. Cl. A47G 1/10; F16M 13/00

(52) U.S. Cl. 248/316.1

(57) ABSTRACT

A holder comprises a base body and a clamp that is supported in a pivotable fashion at a pivot point on the base body with one end and can be brought into a fastening position, in which its other end is snapped into the base body, by turning the clamp relative to the base body.

### CROSS-REFERENCE TO RELATED APPLICATIONS

This application claims the benefit of the filing date of U.S. Provisional Patent Application No. 60/598,567 filed Aug. 3, 2004, the disclosure of which is hereby incorporated herein by reference.

### BACKGROUND OF THE INVENTION

The invention relates to holders and, in particular, to cable holder for holding and guiding bundles of electric cables in aircraft.

Known cable holder used in aircraft are usually difficult to mount, wherein an exchange of such a cable holder during the course of maintenance procedures can only be carried out with a special tool and consequently is quite time-consuming.

### SUMMARY OF THE INVENTION

According to an exemplary embodiment of the invention, a holder is provided which comprises a base body and a clamp, wherein one end of the clamp is supported on the base body in a pivot point, and wherein the clamp can be brought into a fastening position, in which its other end snaps into the base body, by turning the clamp relative to the base body. The clamp may be inserted into the base body at the pivot point at an angle of 90° and may be closed by turning. In this case, the clamp may be automatically secured, namely geometrically in the pivot point on the bottom and in the interlocking region on the top.

At least one projection may be provided on the end of the clamp that snaps into the base body, wherein this projection snaps into an opening arranged in the base body when the clamp is turned into the fastening position. In the opening, a pin extends in the direction of the snapped-in projection such that the tab is prevented from unintentionally sliding out.

For opening, the pin may be realized in a flexible fashion and may need to be pressed aside, for example, by means of a screwdriver. The pin may then return into its original position.

In its upper region, the holder according to an exemplary embodiment of the invention makes it possible to realize a rapid-action interlock that has a high reliability of operation and can be easily installed and serviced. The holder may be made of plastic and manufactured by means of injection-moulding. This means that the holder represents an inexpensive mass-produced part, so that that the installation times/costs are reduced. During maintenance procedures, the cables that may be clamped or penned in, according to the invention, between the base body and the clamp can be very quickly exchanged “in situ” without requiring special tools. The warehousing/variety of parts can be reduced because the clamp is suitable for use on the left as well as on the right side of an aircraft.

The holder according to the invention may make it possible to hold and guide, in particular moving, electric cables and to simultaneously protect these cables from mechanical damages on structural components.

According to an exemplary embodiment of the invention, a holder is developed for holding and guiding cables (bundles of cables) that can be inexpensively manufactured, has a high reliability of operation and can be easily installed and serviced.

One exemplary embodiment of the invention is described below with reference to the enclosed figures. Identical elements are identified by the same reference symbols.

### BRIEF DESCRIPTION OF THE DRAWINGS

The figures show:

FIG. 1, a perspective representation of the exemplary embodiment of a holder according to the invention.

FIG. 2, a cross sectional view of the holder according to FIG. 1.

FIG. 3, a detailed cross sectional view of the lower region (pivoting region) of the holder according to FIG. 1.

FIG. 4, a partial perspective representation of the upper region (interlocking region) of the holder according to FIG. 3 viewed from the rear.

FIG. 5, a cross sectional view of the interlocking region of the holder according to FIG. 4.

### DETAILED DESCRIPTION

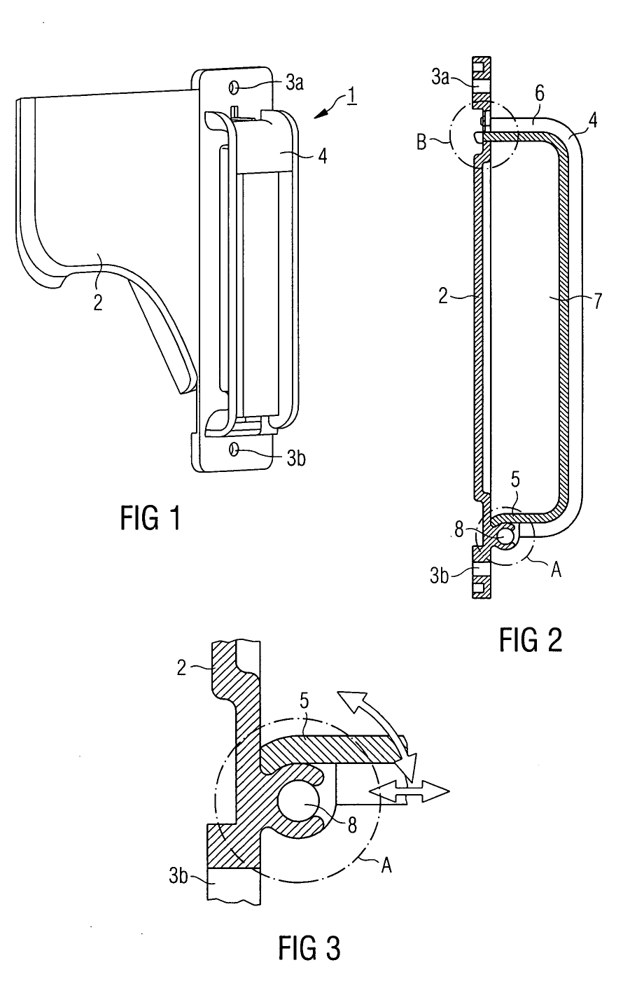

FIG. 1 shows a perspective representation of one exemplary embodiment of a holder 1. The holder 1 comprises a base body 2 that may be made of plastic. The base body 2 contains bores 3a, 3b for being screwed, for example, to a structural component (transversal carrier or frame).

According to the invention, the base body 2 may have such a shape that it can be easily mounted, in particular, in the region of the aircraft door. It is also possible to realize different shapes of the base body 2 in dependence on the point of installation.

The holder 1 also comprises a clamp 4 that is attached to the base body 2 on both of its end regions.

FIG. 2 shows a cross section through the holder according to FIG. 1.

FIG. 2 clearly shows that the clamp 4 is realized in a U-shaped fashion and is supported on the base body 2 in a pivoting region A with its leg 5, wherein the other leg 6 of the clamp is engaged with the base body 2 in an interlocking region B.

For example, cables may extend in the space 7 formed between the clamp 4 and the base body 2 and are clamped against the base body 2 by the clamp 4.

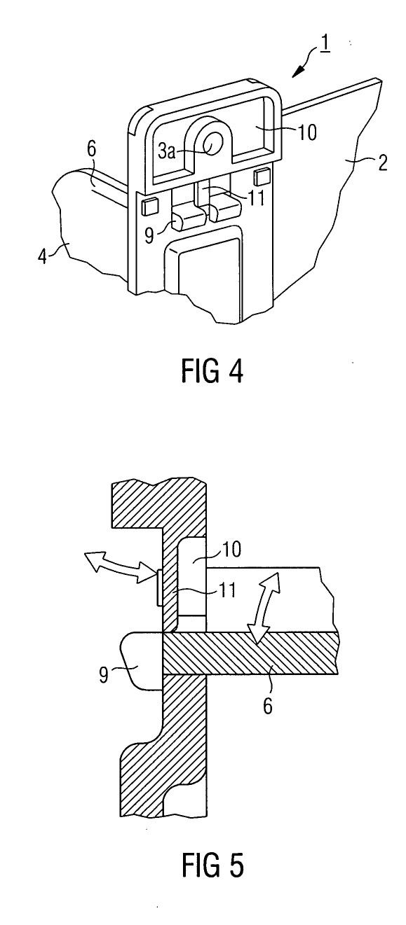

The pivoting region A is described below with reference to FIG. 3, and the interlocking region B is described below with reference to FIGS. 4 and 5.

FIG. 3 shows a detailed cross section through the pivoting region A according to FIG. 2.

When installing the clamp 4, it is initially inserted into the base body 2 at the pivot point 8 at an angle of 90°, as indicated by the horizontal double arrow. The end region of the leg 5 of the clamp 4 is suitably designed, for example, such that it can be clamped into a correspondingly designed clip on the base body 2 by means of a press fit. According to the exemplary embodiment, the clamp 4 is then pivoted upward by 90° as indicated by the other double arrow. This automatically causes the clamp 4 to be geometrically secured at the bottom in the pivot point.

FIG. 4 shows a perspective representation of the interlocking region B of the holder according to FIG. 3.

According to FIG. 4, a pair of tabs or projections 9 is arranged on the end region of the leg 6 of the clamp 4. For example, the pair of projections 9 is injection-moulded onto the leg 6 of the clamp 4.

As mentioned above, the clamp 4 is initially inserted into the base body 2 at the pivot point 8 at an angle of 90° and then pivoted upward by 90°. During this process, the projections 9 snap into an opening 10 arranged in the base body 2 as shown in FIG. 4. The projections 9 may have such a shape that they are prevented from accidentally sliding out of the opening 10.

According to the invention, the holder 1 also comprises a pin 11 that is arranged in the interlocking region B and additionally secures the projections 9 snapped into the opening 10 of the base body 2 from sliding out.

FIG. 5 shows a cross section through the interlocking region of the holder according to FIG. 4.

FIG. 5 clearly shows that the pin 11 extends from an upper region of the opening 10 of the base body 2 to the surface of the limb or leg 6 of the clamp 4. The pin 11 is preferably made of plastic and injection-moulded onto the base body 2, wherein its free end extends to the surface of the leg 6 and, for example, slightly contacts this leg surface. In FIG. 5, the projections 9 are snapped into the opening 10. In order to separate the clamp 4 from the base body 2 in the interlocking region B, for example, for installation or servicing tasks, the pin 11 needs to be pressed aside, for example, by means of a screwdriver as indicated by the left double arrow, and the projections 9 need to be pushed upward as indicated by the right double arrow and pulled out through the opening 10. The pin 11 then once again returns into its original position. The pin 11 thusly prevents the leg 6 of the clamp 4 from being unintentionally moved upward and the projections 9 from accidentally sliding out or snapping out of the opening 10.

Although the preceding description of the invention referred to one exemplary embodiment, it should be understood that this embodiment could be modified and changed in different ways without departing from the scope of the invention. For example, it would be possible to choose another suitable shape for the clamp in order to fix parts other than electric cables on the base body. It should also be understood that the holder according to the invention is not only suitable for use in aircraft, but also in the automotive industry or in other fields, in which electric cables or conduits need to be reliably held and guided such that they can be easily serviced.

The holder according to the invention is not only suitable for holding bundles of cables, but may also be designed for holding pipes or hoses. The holder is particularly suitable for holding movable cables.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A holder, comprising
a base body; and
a clamp;
wherein the clamp is supported in a pivotable fashion at a pivot point on the base body with one end and can be brought into a fastening position, in which its other end is snapped into the base body in order to fasten the clamp on the base body, by turning the clamp relative to the base body;
wherein the one end of the clamp can be inserted into the pivot point at an insertion angle and is geometrically secured in the pivot point when the clamp is turned into the fastening position.

2. The holder of claim 1, wherein at least one projection is provided on the other end of the clamp, and wherein said projection can be pressed into an opening in the base body and snaps into said opening when the clamp is turned into the fastening position.

3. The holder of claim 2, wherein the at least one projection snapped into the opening is secured from sliding out by a pin that extends into the opening.

4. The holder of claim 3, wherein the pin is realized in a flexible fashion and needs to be pressed aside when snapping the at least one projection into and out of the opening.

5. The holder of claim 2, wherein a pair of projections snaps into the opening provided in the base body, and wherein the pin is realized between the pair of projections in the order to prevent sliding out.

6. The holder of one claim 1, wherein the clamp is realized in a U-shaped fashion and is adapted to clamp at least one cable against the base body in the fastening position.

7. The holder of claim 6, wherein parts of the U-shaped clamp protrude into the base body in order to absorb lateral forces.
